(19) United States
(12) Patent Application Publication
(10) Pub. No.: US 2014/0058786 A1
(43) Pub. Date: Feb. 27, 2014

(54) SYSTEMS AND METHODS TO ENHANCE OPERATIONAL PLANNING

(71) Applicant: Louis David Marquet, Laurel, FL (US)

(72) Inventor: Louis David Marquet, Laurel, FL (US)

(21) Appl. No.: 13/969,177

(22) Filed: Aug. 16, 2013

Related U.S. Application Data
(60) Provisional application No. 61/684,649, filed on Aug. 17, 2012.

(51) Int. Cl. G06Q 10/06

(52) U.S. Cl. CPC G06Q 10/06316
USPC 705/7.26

(57) ABSTRACT

Operational planning may be beneficial in a wide variety of areas. For example, naval commanders, hospital administrators, educators, and cargo transporters may benefit from enhanced operational planning. A method can include presenting a list of events in a chronological order. The method can also include linking each of the events to at least one chronological neighbor event, said linking done with respect to a non-chronological parameter of said at least one chronological neighbor event. The method can further include, responsive to a user selection, changing the chronological order of the list of events. The method can additionally include relinking events having at least one changed neighbor event upon changing the chronological order.

### CROSS REFERENCE TO RELATED APPLICATIONS

This application is related to and claims the benefit and priority of U.S. Provisional Patent Application No. 61/684,649 filed Aug. 17, 2012, which is incorporated herein by reference in its entirety.

### BACKGROUND

1. Field

Operational planning may be beneficial in a wide variety of areas. For example, naval commanders, hospital administrators, educators, and cargo transporters may benefit from enhanced operational planning.

2. Description of the Related Art

Scheduling software may allow the scheduling and sequencing of events. The events can run in parallel or in series and have assigned interdependencies such as the requirement for one event to be completed prior to the start of another event. However, these scheduler programs lack a geographic element (for example, time-distance-speed) and are built using a computer interface. Moreover, events are not graphically stacked.

Route planners, such as mapping features in phones and in certain global positioning systems (GPS), determine paths from a current position or selected address to a future position or selected address. These mapping applications have a geographic element in that they show distance traveled over time but do not allow the stacking up of multiple events. These route planners may have very limited ability for operators to create their own events, create their own plans, create interfaces allowing team discussion and decision making about plans, allow sharing and archiving of plans, and allow a comparison of actual performance against planned performance.

### SUMMARY

According to certain embodiments, a method can include presenting a list of events in a chronological order. The method can also include linking each of the events to at least one chronological neighbor event, said linking done with respect to a non-chronological parameter of said at least one chronological neighbor event. The method can further include, responsive to a user selection, changing the chronological order of the list of events. The method can additionally include relinking events having at least one changed neighbor event upon changing the chronological order.

In certain embodiments, an apparatus can include at least one processor and at least one memory including computer program code. The at least one memory and the computer program code can be configured to, with the at least one processor, cause the apparatus at least to present a list of events in a chronological order. The at least one memory and the computer program code can also be configured to, with the at least one processor, cause the apparatus at least to link each of the events to at least one chronological neighbor event, said linking done with respect to a non-chronological parameter of said at least one chronological neighbor event. The at least one memory and the computer program code can further be configured to, with the at least one processor, cause the apparatus at least to responsive to a user selection, change the chronological order of the list of events. The at least one memory and the computer program code can additionally be configured to, with the at least one processor, cause the apparatus at least to relink events having at least one changed neighbor event upon changing the chronological order.

A non-transitory computer-readable medium, according to certain embodiments, can be encoded with instructions that, when executed in hardware, perform a process. The process can include presenting a list of events in a chronological order. The process can also include linking each of the events to at least one chronological neighbor event, said linking done with respect to a non-chronological parameter of said at least one chronological neighbor event. The process can further include responsive to a user selection, changing the chronological order of the list of events. The process can additionally include relinking events having at least one changed neighbor event upon changing the chronological order.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates four modes of implementation according to certain embodiments.

FIG. 3 illustrates a data structure according to certain embodiments.

FIG. 4 illustrates a more detailed example of a definition of a mission, according to certain embodiments.

FIG. 5 illustrates a more detailed example of a definition of an event, according to certain embodiments.

FIGS. 6A-6C illustrate a more detailed example of a definition of an execution event, according to certain embodiments.

FIGS. 7A-7B illustrate a more detailed example of a definition of a milestone event, according to certain embodiments.

FIG. 8 illustrates a more detailed example of a definition of a position tag.

FIG. 9 shows an initial user interface view according to certain embodiments.

FIG. 10 illustrates syncing in a user interface according to certain embodiments.

FIG. 11 illustrates selection of a mission for planning according to certain embodiments.

FIG. 12 illustrates an event list view according to certain embodiments.

FIG. 13 illustrates the interrelationship between a time-distance view and a geographic view according to certain embodiments.

FIG. 14 illustrates a combination of a Geo view and an event list view according to certain embodiments.

FIG. 15 illustrates event selection according to certain embodiments.

FIG. 16 illustrates event editing according to certain embodiments.

FIG. 17 illustrates way points in a geographic view according to certain embodiments.

FIG. 18 illustrates editing of a connecting line according to certain embodiments.

FIG. 19 illustrates unbalanced risk displayed to a user in a time-distance view according to certain embodiments.

FIG. 20 illustrates balanced risk displayed to a user in a time-distance view according to certain embodiments.

FIG. 21 illustrates a mission summary ready for submission according to certain embodiments.

FIG. 22 illustrates a system according to certain embodiments.

### DETAILED DESCRIPTION

Certain embodiments can provide a system that can permit a user or team of users to plan and execute an operation. The operation can be a military operation, a cargo transportation operation, a medical operation, or an operation of education, such as a course of instruction. Certain embodiments organize such operations in terms of discrete events. Thus, certain embodiments may rely on thinking of the events as discrete and quantized within the operation. The events can, therefore, be bounded, defined, counted, modified, tracked within a structured system.

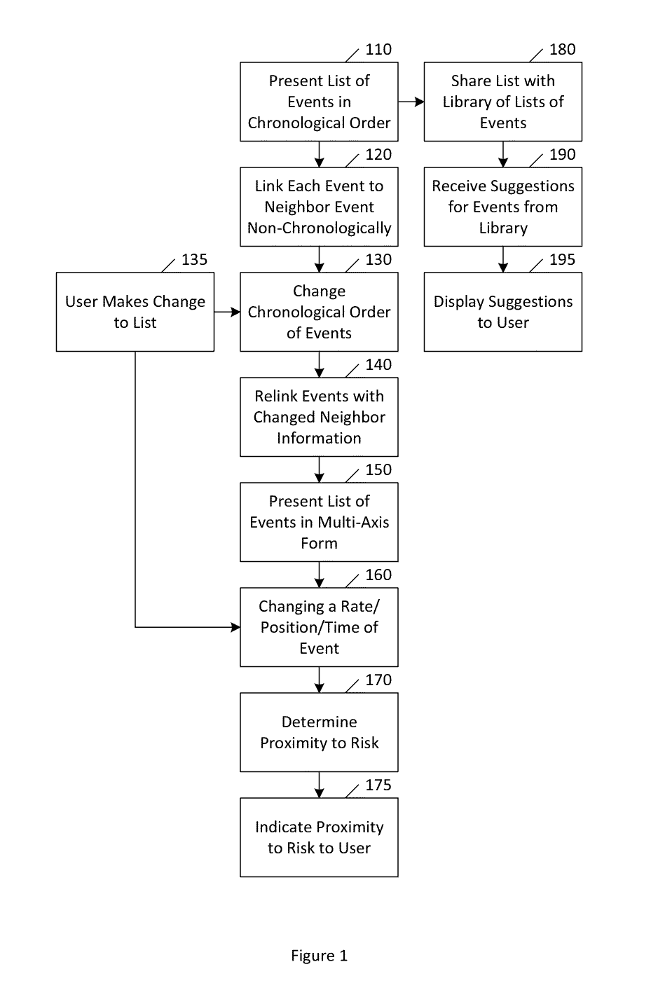

FIG. 1 illustrates a method according to certain embodiments. The method may be a method whereby a system, such as a processor or controller-based system, can enable operational planning by a user or team of users. As shown in FIG. 1, a method can include, at 110, presenting a list of events in a chronological order. This list of events can be presented in analogous way to the way that a musical playlist is arranged, with an event being analogous to a particular song on the playlist. The presentation can, for example, show each event within a box. The box can be labeled with a brief description, such as “check in patient,” or the box can be labeled with a list of steps associated with the event or with a narrative description of the event. Additional information can include an instructional video, a testimonial or review, or a lesson learned from a previous user or previous team.

The method can also include, at 120, linking each of the events to at least one chronological neighbor event. The linking can be done with respect to a non-chronological parameter of said at least one chronological neighbor event. In other words, if there are five events in a series list of events, the first event may have one neighbor, namely the second event in the series. The second through fourth events may each have two neighbors. Finally, the fifth event may have only one neighbor. The first event can also be linked to a starting point and/or the last event can also be linked to an endpoint.

Each event can be defined by a process and an endpoint in time and position. Alternatively, each event can be defined by a process and a starting point in time and position. In a further embodiment, each event can be defined by both its starting point and its endpoint.

Linking each of the events can include beginning a process of a second event at an endpoint of the first event. The process of the first event can begin at a starting point. The user can select or define the starting point. In embodiments where events happen in parallel, a third event can also begin at the endpoint of the first event. For example, a patient may be receiving intravenous fluid while being transported to another location.

Thus, for example, certain embodiments define events by end positions and end times. Thus, each event can inherit its own start position and start time automatically from the preceding event. There can also be an initial null start event, which may have no duration, but which can have simply a time and place.

The non-chronological parameter can include a geographic parameter. For example, the non-chronological parameter can be a two-dimensional or three-dimensional geographic position. In certain embodiments, the geographic positions can be rooms or hallways in a hospital or positions within a factory work area, or positions on land, in space, airspace, on or under the water.

While in certain embodiments, the non-chronological parameter may be geographic, in other embodiments the non-chronological parameter may be some other parameter. For example, in certain embodiments, the system can be used for instruction of students, such as to provide lesson plans in connection with a course syllabus. In such a case, the non-chronological parameter could be pages in a textbook or some other parameter.

In addition to the kinds of events discussed above, which take time and space, there may be another category of events, referred to as milestones, which do not take time or space. For example, “launch unmanned aerial vehicle (UAV)” can be a normal event, whereas “pass point alpha” can be a milestone. Milestones can be inserted into the list like normal events. The system can treat milestones as a special subset of events with zero time and zero distance.

The method can also include, responsive to a user selection, at 130 changing the chronological order of the list of events. For example, a user may drag and drop a box associated with one of the events into a different chronological position with respect to the other events. Alternatively, the user may insert a new event into the list or the user may delete an event from the list. The user may also choose to randomly shuffle the events in the list. In each of these cases, the original chronological order can be deemed to be changed. The user can also change the chronological order in more subtle ways, such as by changing a time or position of a starting point or of any endpoint.

Users can add new events that have been previously defined by other users, can add new events previously defined by the users themselves, or can choose to define the users' own event. Alternatively, the users can opt to modify a pre-existing event.

The method can also include, at 140, relinking events having at least one changed neighbor event upon changing the chronological order. In other words, in a case where an event is simply added to the end of the list, only the previously last, and now penultimate, event may need to be relinked. However, if a new event is inserted into the middle of the list many of the events may be effected in terms of either time or position. Thus, the events may be dynamically relinked in response to user manipulation of the chronological order. Changing times or rates of the events can also be considered changing the event for the purposes of related events having at least one changed neighbor event.

Some modifications to an event can effectively create a new event, while others may not. For example, changing a maximum speed for an event from 10 kts to 15 kts may change that event and create a new event. Defining the time and position for the event can, in certain embodiments, be treated simply an application of that event to that operational mission, and may not requiring spawning an additional event.

The method can also include, at 150, presenting the list of events on a plurality of axes, the plurality of axes comprising a time axis and a position axis. This presentation mode can be presented simultaneously with the playlist-like presentation. Alternatively, this presentation mode can be selectably presented to the user, with the user selecting which presentation mode to employ at a given time. For example, there can be a tab for a playlist view and a tab for the multi-axial view, and the user can select between the views.

The method can further include, at 160, responsive to a user selection changing a rate of a process of an event, changing an endpoint of the event, and changing at least one of a rate or an endpoint of a neighbor event. Thus, for example, if a process associated with an event is accelerated, this may change the chronological starting point of the next event in the series. This may have a ripple or chain-reaction effect on all subsequent events in the series. In some cases, an endpoint of an event in the series may be fixed to a particular time and/or location. In such a case, the ripple may not extend beyond this fixed point. In some cases, these fixed points may make performance of the series of events impossible. In such a case, the system may warn the user that the new list of events is impossible.

The method can additionally include, at 170, determining a proximity to risk for each event. The method can further include, at 175, indicating the proximity to risk to the user. For example, the indicating the proximity to risk comprises changing a color associated with the event. Thus, for example, events can have a range of possible rates associated with an event. For example, in the case of cargo transportation, a truck may have a maximum possible speed (such as the speed set by a governor of the truck). As the average speed of the truck over a leg of a trip approaches this maximum possible speed, it can be determined that the risk of the event not succeeding can increase. Thus, if the truck must travel on average at only 75% of the maximum speed, then the risk may be indicated as low. This indication may be made by making the box or line(s) associated with the event green, not flashing, or pulsing calmly. If the truck must travel at 85% of the maximum speed, then the risk may be indicated as moderate. Moderate risk may be indicated as yellow, some flashing, or a moderate level of pulsing. If the truck must travel at 95% or more of the maximum speed, then the risk may be indicated as severe. Severe risk may be indicated as red, constant flashing, or high speed pulsing. Other indication schemes are also possible.

The 75%, 85%, and 95% values are just examples. The system or the user can set thresholds for what constitutes various levels of risk. These risk levels can be indicated in a finely graduated fashion. For example, the color can smoothly change from green to red or the rate of pulsing can slowly increase. Alternatively, the indications can be limited to simply two or three indications. Other indications, such as badges or icons, can also be used.

Moreover, in certain embodiments the absolute speed may not be what defines risk, but rather speed relative to some local standard of speed. For example, while a truck may be capable of going significantly over 55 mph, even a speed of 35 mph may be deemed a severe risk when the truck is passing by an elementary school.

Other views are also possible. For example, a geographic view, such as a map view, can be another presentation to the user. The geographic view can permit the user to change the position associated with a starting point or endpoint of any event. Likewise, the geographic view can permit users to insert events. As with the multi-axial view, the geographic view can have color indications for proximity to risk. The geographic view can be presented simultaneously with the playlist-like view, the multi-axial view, or both views.

The geographic view can be used by the user in the manipulation of events. For example, when a user drags an event onto the screen in the geographic view, the system can assign appropriate relationships for it.

For example, the system can know the distance between each event. An arbitrary event N can be any event from A-ZZZ (or any range of events). When a new event is placed on map, the system can find the event closest to the new event. This closest event can be event N.

The system can check the distance to the event before N, namely event N−1, and compare that distance to the distance between N−1 and N. In other words, the system can check whether the new event is closer to the previous event than to the next event in series. If so, then the system can insert the new event before N and after N−1. If not, then the system can insert the new event after N and before N+1.

Additional views are also permitted, such as spreadsheet views associated with costs and/or materials associated with the events or participants in the event. In certain embodiments, one presentation mode can illustrate the process in a Gant chart format.

The method can also include, at 180, sharing the list of events with a library of lists of events. For example, drivers can share lists of cargo transportation trips with a dispatch center. Similarly, the sharing can involve sharing mission plans with a library of mission plans. Likewise, nurses can share lists of patient treatment approaches with doctors or hospital administrators. In certain cases, users at the library or another remote location can review the list of events, modify them, and return them to the user. Also, the user may retrieve events from the library in building the list. The library may inform the user regarding apparently related events, such as events that are highly correlated with the events that the user is employing. For example, a hospital library may have a record of many patient procedures. When an operation list of events for replacing a hip is prepared by the user, the library may suggest events that are commonly associated with hip replacement, such as anesthesia or scheduling post-operative physical therapy. The user can select events at will and can take the library's suggestions into account. Thus, the method can also include, at 190, receiving suggestions of events from a library of events, and, at 195, displaying those suggestions to the user.

There can be a self-learning aspect to certain embodiments. As users select preplanned missions and pre-defined events, the system can count how many times each mission and event is opted for by users, which can then be used to indicate the most helpful missions and events. Another part can simply be having a graphical way to see what others have done before and where others have done it.

The sharing can also provide a visibility aspect. All units can coordinate when they or at least some superiors have visibility of the other units. For example, a submarine team, an airplane team, and a SEAL team may coordinate operations either by sharing with one another or by sharing with commanders that command all three teams.

In certain embodiments, each time a change is made or periodically, changes can be shared with other unit(s) or user(s) for the purposes of coordination or approval. For example, a SEAL team can change their mission indicating they will be an hour late for the extraction point. This can get transmitted to the submarine, where the submarine team can dynamically re-plan the submarine team's mission to arrive at an appropriate time.

In certain embodiments, a category of events referred to as shared events can be considered. These shared events can be events that are shared by at least two units, requiring both units to be in the same place at the same time. Thus, changes to shared events may require coordination and approval, either of the units/users or of a manager/supervisor/commander.

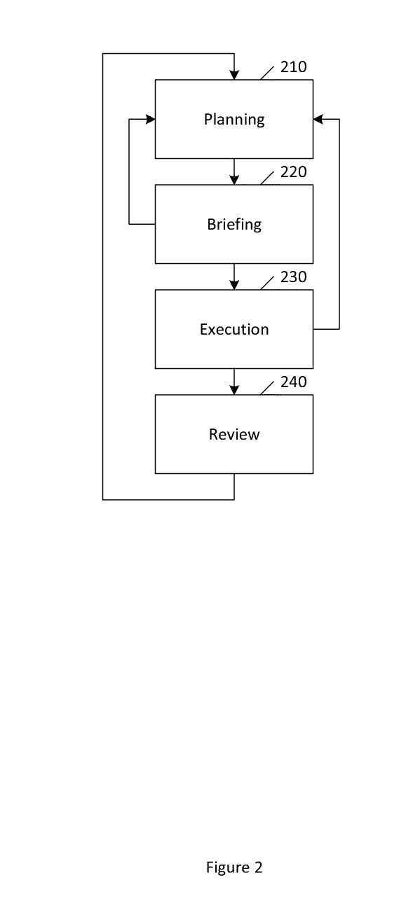

FIG. 2 illustrates four modes of implementation according to certain embodiments. As shown in FIG. 2, implementation can include a variety of steps. At 210, the implementation can include planning. During planning, tracking of approval and review of the plan can be conducted. During planning the user or team may manipulate the plan while adding, removing, or modifying events in the plan.

Then briefing can occur at 220. Here, the plan can be presented to a broader team and distributed for review. The team can then provide feedback. This may lead to additional planning at 210.

Alternatively, briefing may lead to execution at 230. In execution, the actual positions and times can be recorded and presented against the plan, allowing visual feedback to the user on how they are doing. Actual time to complete an event can be recorded. Thus, for example, the presentation can include a display of the planned events, including time and position as well as a current actual time and position. In some cases, the users may decide to return to the planning stage, particularly if the execution is deviating significantly from the plan. This may be part of a learning process. For example, a user may plan an event, such as “launch UAV”, to take 15 minutes. The user may then discover with user experience that the actual distribution of times to launch the UAV includes some values that are longer. Thus, the user can more intelligently select a time during the planning phase. For example, the user may conservatively plan for the time to be toward the long end of the distribution, or the user may optimistically plan for the time to be toward the short end of the distribution.

Records of execution can provide an intimate look into existing performance. For example, such records can confirm how long it takes to complete a particular event, such as the time necessary for a submarine to come to periscope depth. Moreover, such records can confirm how often a event occurs, such as the number of times in a year a submarine came to periscope depth. Furthermore, such records can confirm the location or context of such events, such as where the submarines came to periscope depth. Thus, such a system may allow feedback into the training system, because there is visibility on what the entire organization is actually doing.

After execution, at 240 there can be a review. This review can focus on lessons learned during the execution. The system can solicit specific feedback from the user regarding the quality of the plan and its correspondence to reality. Additionally, the record of the execution can be compared to the plan to evaluate whether the plan's assessment of risk was realistic, particularly when taken as part of an average in combination with other executed plans. This review can then be used again in later planning at 210.

Certain embodiments can be used for various purposes. For example, the system may fill a void in operational planning software applications between schedulers and route planners, and may take advantage of an intuitive graphical user interface, which may work with devices such as tablet computers and handheld devices.

Although certain embodiments are portrayed using submarine operational planning as a use case, certain embodiments may be more widely applicable to any process or project that contains a sequence of events, whether or not they contain geographic dimensions. Some examples of applicable uses include the following: curriculum planning, development and sharing; medical and hospital procedure planning, development, and sharing; logistical planning for railroads, airlines, and couriers; military operational planning including logistics, transportation, campaign, and battle planning; maintenance planning; project management; and construction and manufacturing.

Certain embodiments, more particularly, can serve as a collaborative file sharing and editing application that uses a “playlist and song” approach to building mission plans.

The application architecture can be based upon the following: first, that missions, plans, and events may be structurally analogous to the “playlist and song” approach users are familiar with; secondly, that the sharing of these developed missions and events among users may yield significant collaboration; and thirdly, that any electronic file, such as lessons learned, videos, and instruction manuals, can be shared over the same network over which the mission and event files are shared.

As such, mission plans can be built from lists of events just as playlists are built from lists of songs. While playlist length and genre can be determined by song selection and order, the mission plan can be determined by selection and order of events. Once planned, missions can be briefed, executed, and assessed.

Thus, for example, operations can be made up of groups of missions. Missions can be made up of playlists of events, which can be expressed as execution and milestone. The events can have properties, including constraints, checklists, procedures, and tactical aids.

The familiarity of the interface can be useful in that events, like songs, can have properties. Songs typically have properties such as genre, artist, year and duration. Operational events that make up the mission playlist can have properties such as planned speed, maximum speed, watchbill requirements, and associated checklists and procedures. Since the system can be a file sharing application, events and missions can be shared like songs or playlists among the user community. The events and missions can likewise be sorted by popularity and relevance, and can be commented on and updated. The structure of the system can leverage previous user knowledge and documentation in assembling mission plans.

The operational planner can be integrated with the organizations certifications and qualifications programs. For example: an operation may require a head surgeon, an assistant surgeon, an anesthesiologist, a head nurse, and a scrub nurse. Part of the planning requirements may include identification of the people involved or possibly required, by qualification and position. The planner can then check a database in the organization to ensure those assigned have the required qualifications.

In certain embodiments, there can be two different classes of events: execution events which take up time and space, such as a transit event, and milestone events which do not, such as decisions and deliverables.

Although certain embodiments are explained with reference to submarine examples, other embodiments may be applied to other moving objects, such as trains, delivery trucks, and unmanned vehicles, as well as sequencing non-geographic missions such as school curriculum, maintenance or medical procedures.

Certain embodiments can provide a structure for assembling and sharing the basic building blocks of plans. All plans and events can be defined, built, and shared by the users. Because of this, new missions, such as a UAV launch, can be defined by the user and incorporated into mission plans without modification to the software. In fact not only could a submarine event “launch UAV” be added, but the UAV mission itself could also be planned on the system. The UAV mission may include events such as launch, broach, achieve flight, transit to position, activate sensor, report, and recover. Hence, the submarine's operations can be made up of loops and branches of mission plans, all using the same structure, format, and interface.

Because certain embodiments employ a file sharing structure, certain embodiments may permit the sharing of both planned and executed missions. Thus, for example, individual submarine commanders could transmit their operational plans or individual mission plans to their operational commander for review prior to execution, much as overlays for Tomahawk® Land Attack Missile (TLAM) launch are done now.

Certain embodiments can track the frequency of use of mission plans and events. Aggregate data can be assembled at the force level about the relevance of events allowing conclusions such as “what are the key event building blocks that would allow a submarine to complete 90% of all missions?” These data could then be factored into pre-deployment training and certification processes to make them more efficient.

The file sharing structure can also allow significant extensions. For example, slideshow training plans, user created video and content, Submarine On-Board Training (SOBT) videos, Program Afloat for College Education (PACE) courses, and maintenance plans could also be shared.

Certain terms are used herein in a particular way. For example, the term “event” can refer to the basic building blocks of missions. Events can be handled in a way that is analogous to songs in a playlist. There can be at least two types of events: execution events that take time and space and milestone events that do not, such as decisions. Events can have properties that describe them. Execution events can be made up of one or more legs. Events can have geographic coordinates assigned to them, although this is not required. Once executed, events can have the actual track of the event stored.

The term “mission” can refer to a collection of events. A mission can be analogous to a playlist itself. A mission can be relatively simple, such as a trip to periscope depth comprising 30 minutes of activity, or complex such as a SEAL team insertion and extraction comprising 48 hours or more of activity.

There can be at least two types of event properties: core properties and operational properties. Core properties can be things such as maximum speed, name, and the like, which do not change based upon the operational planning. They can be changed and customized by the user. Operational properties can be properties such as speed, start and stop position, and the like, which are affected by the specific operational plan. Geographic positions can be both core and operational. A planned transit event may have previously stored geographic positions and the planned transit may match previous geographical positions, or may have modified geographic positions.

The term “operations” can refer to groups of missions either from various units such as submarine, SEAL team, and UAV, or sequenced by the same unit.

The term “leg” can refer to a segment of an event. A leg can be defined by the attributes of start and end positions and time. The leg can be bounded by an articulation point.

The expression “articulation point” can refer to a point within an event that changes the path but not the event properties such as speed. Articulation points can be used to route a unit around obstacles during an event such as highway travel or deep water transit.

Certain embodiments can have various functional and structural characteristics. For example, in certain embodiments there can be a variety of user roles. One user role can be that of a planner. A planner can open, find, build, and modify missions.

Another role can be that of a reviewer. A reviewer can review missions, comments on missions, and modify missions. Similarly, a user in the role of an approver can approve the mission. Finally, a user in the role of an operator can view the mission during operation.

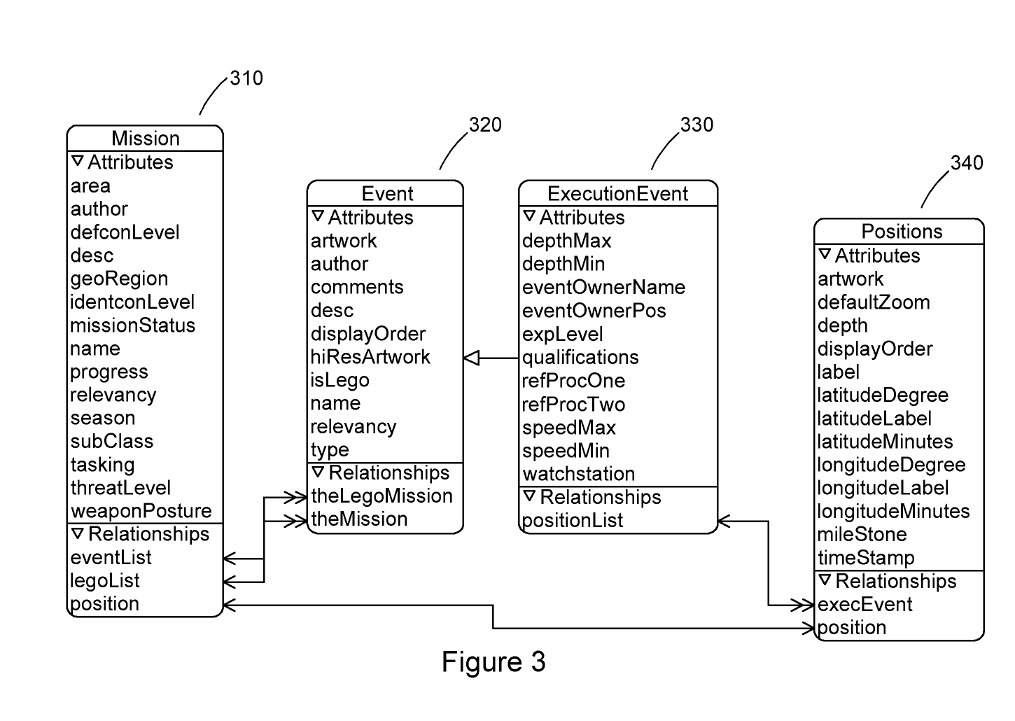

FIG. 3 illustrates a data structure according to certain embodiments. Events can be handled in a variety of ways. As mentioned above, a series of events 320 may be used to create a mission 310. Additionally, in certain embodiments events can be provided in parallel. Events may be milestone events or execution events 330. Execution events can take up time and space, such as transit. Milestone events do not take time or space, such as decisions and deliverables.

In certain embodiments, unless otherwise specified, all data entry fields can be standard string data type. The user may enter any value (text, numeric, special characters, or the like) up to 255 characters.

Thus, position 340, when referring to a specific geographic position, can include the following data elements in certain embodiments: latitude degrees with a format of xx° xx.x′; latitude minutes; latitude label (N/S); longitude degrees with a format of xx° xx.x′; longitude minutes; and longitude label (E/W). Other data elements can be used instead, if desired. A non-exhaustive list of possible attributes for positions 340 is shown in FIG. 3.

In certain embodiments, a user can have the ability to create, edit, and delete execution and milestone events. When a user creates an event, the event can be saved and may be viewed by other users. When a user edits an existing event, a new version of the event can be created.

An event that is deleted can be removed from the application. Alternatively, deleted events can be archived for possible future usage.

The ability to create, edit, and delete an event is based upon user role, as discussed above. Thus, for example, in certain embodiments a user may have to authenticate to a particular role before being able to perform a particular action with respect to a mission or event. A user with a planner role, for example, may have the ability to add an event to a mission.

Events 320 can, in certain embodiments, have the following properties: name; author, which can be automatically populated based on user login/authentication; description; comments; and artwork or image(s), which can be uploaded from the user's tablet or other device based on local storage or over the Internet. Other attributes are also possible. A non-exhaustive list of such attributes is shown in FIG. 3.

An event may be an execution event, like execution event 330, or milestone event, as mentioned above. Execution events can be made up of multiple straight legs that are stored as positions and timestamps. Other ways of describing events are also possible. For example, events can be made up of multiple routes or paths, such as highways or predetermined paths.

Milestone events do not take time or space, as mentioned earlier. Milestone events can include things such as decisions and deliverables. Milestone events can be viewed as execution events with zero time. Thus, if an event is assigned zero time, then the system can drop the event in as an milestone event.

A user can, in certain embodiments, be presented with the option to search for an event. Event search results can display relevancy to allow the user a visual indicator of how closely the results matched the search. When searching for an event, the user's results can be limited to events with the same unit.

Missions, such as mission 310, can be handled similarly to the way that events are handled. For example, as with events, unless otherwise specified, all data entry fields can be standard string data type. The user can enter any value (text, numeric, special characters, and the like) up to 255 characters.

In certain embodiments, a user can have the ability to create, edit, and delete a mission. As with events, this ability can be limited according to the user's role(s).

In certain embodiments, when a user creates a mission, the mission can be saved and may be viewed by other users. Likewise, when a user edits a mission, a new version of the event can be created. A mission that is deleted can be removed from the application or can be archived for possible future use.

In certain embodiments, a user can have the ability to add and remove events from a mission. The ability to add and remove events from a mission can be based upon the user's role, as mentioned above.

When an event is added to a mission, the system can automatically assign a sequence number to the event. The sequence number can automatically update when a user changes the order of events in a mission.

When a mission is initially created by a user or created by modifying an existing mission, the mission can display to the user with a planning status. Later, the status can change as mission planning moves to briefing, execution, and review, as discussed above with reference to FIG. 2.

In certain embodiments, the minimum number of fields to create a mission can be as follows: for an execution event or a milestone event, a name and sequence number, which can be system assigned. Additional fields and/or attributes are also possible. FIG. 3 illustrates a non-exhaustive list of such attributes.

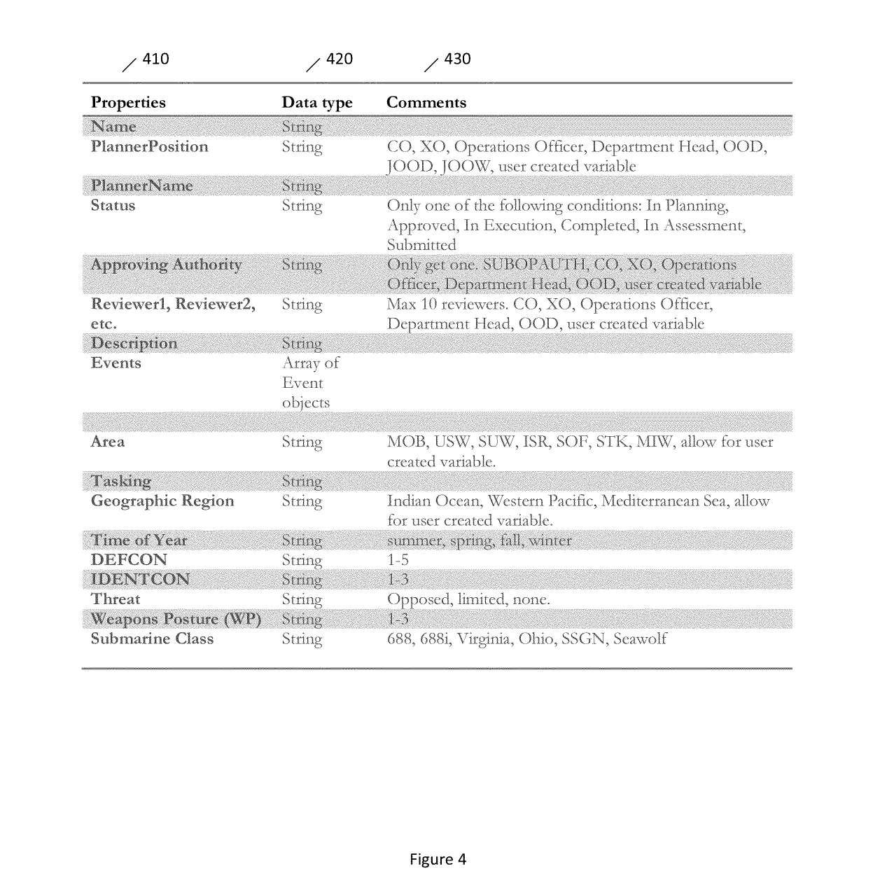

FIG. 4 illustrates a more detailed example of a definition of a mission, according to certain embodiments. As shown in FIG. 4, the definition may include properties 410, data type 420, and comments 430. The properties 410 can include things such as name, planner position, planner name, status, and the like. The data type 420 can include things like string or array of event objects. The comments 430 can provide the values for the properties, particularly in the case of string data type properties.

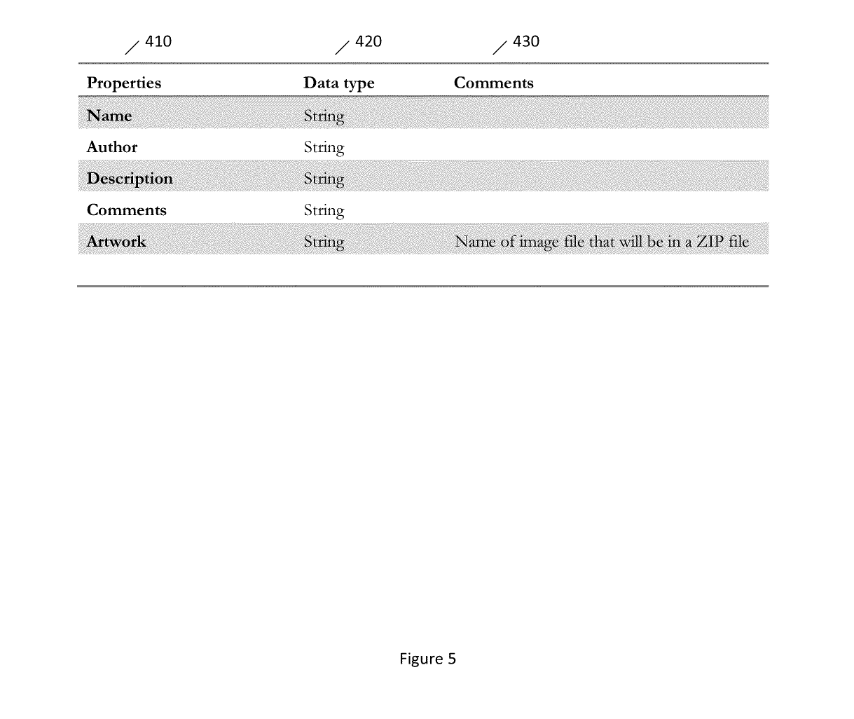

FIG. 5 illustrates a more detailed example of a definition of an event, according to certain embodiments. As shown in FIG. 5, the definition may include properties 410, data type 420, and comments 430. The properties 410 can include things such as name, author, description, comments, and artwork. The data type 420 can include things like string or array of position objects. The comments 430 can provide the values for the properties, particularly in the case of string data type properties.

Like songs, events can have properties and information. Event files can also have tags. Certain specific fields can define the event. Changing some fields will cause a new event to be created, as mentioned above. Some events can live in families. For example, “deep water transit” can be a family of which deep water transit with a particular physical location associated can be a member of the family.

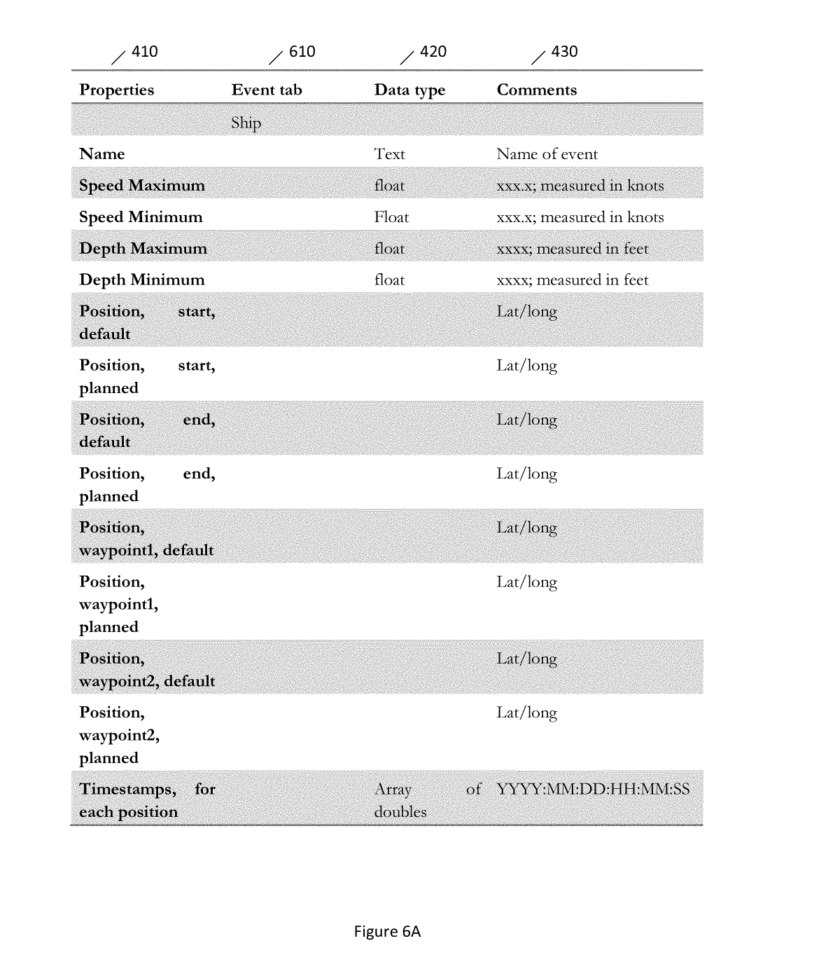

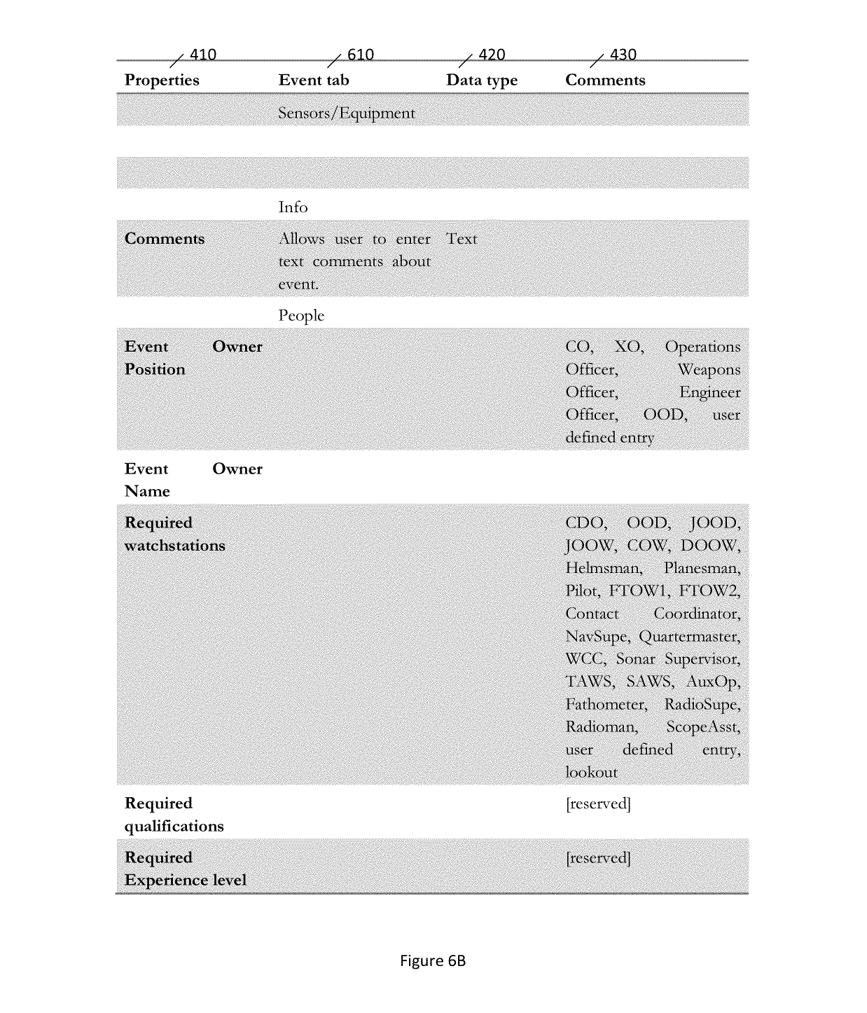

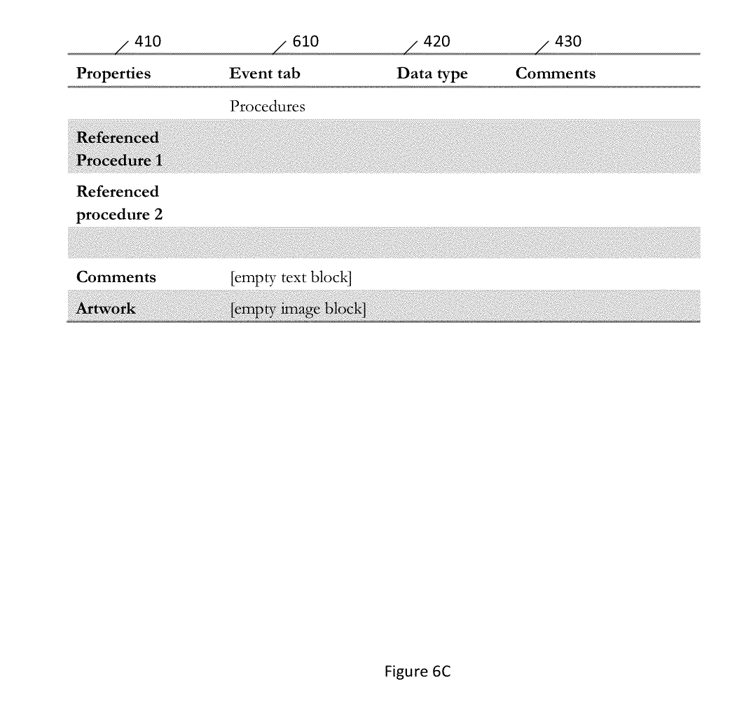

FIGS. 6A-6C illustrate a more detailed example of a definition of an execution event, according to certain embodiments. As shown in FIGS. 6A-6C, the definition may include properties 410, data type 420, comments 430, and event tab 610. The properties 410 can include things such as name, speed maximum, speed minimum, depth maximum, depth minimum, and so on. The data type 420 can include things like text, floating point integer, array doubles, or the like. The comments 430 can provide the values for the properties, particularly in the case of text and float data type properties. The event tabs 610 can include things like ship, sensor/equipment, information, people, and procedure.

An execution event definition can be viewed as an extension of an event definition. Execution events can take time and space. They may be made up of multiple legs that are stored as positions and timestamps. Turns can also be included as legs of the execution events.

Sometimes speed may be a primary attribute, as in a shallow water transit. Sometimes duration may be a primary attribute, as in loading a torpedo. Sometimes end time may be a static attribute, as when the object is to be at a particular point by a particular time.

The attributes can also include planned values as well as nominal values for these things like starting position. The nominal values can be those stored in a common database, whereas the planned value can be the specific one modified by the user, such as the person operating a ship.

Derived values can include speed, duration, course, and length. These values can be derived from the position and time values.

An example of the Time-Distance display, discussed below, shows two events and not the internal legs of the events. Nevertheless, individual legs could similarly be displayed to the user. When the entire event has the same speed, it may be unnecessary to display the individual legs as such to the user.

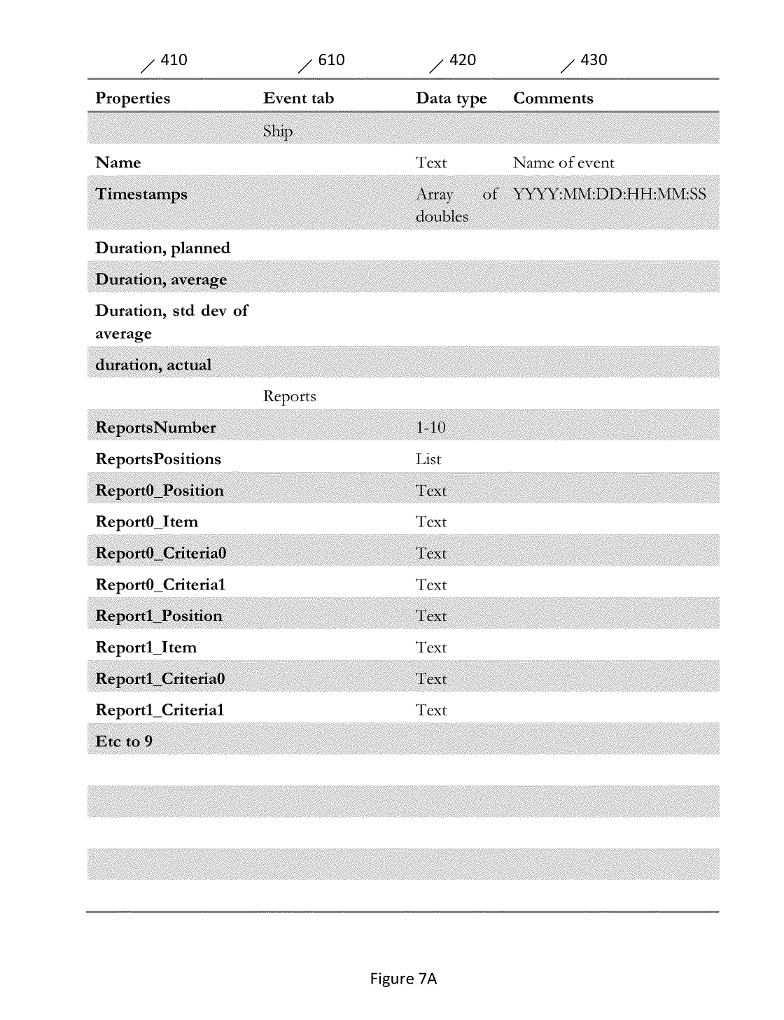

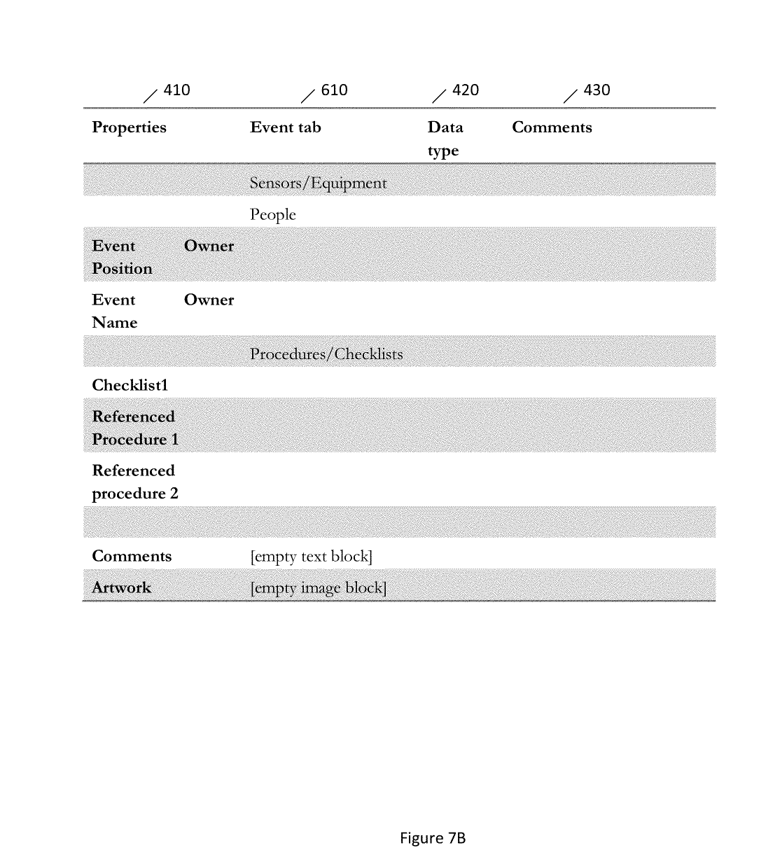

FIGS. 7A-7B illustrate a more detailed example of a definition of a milestone event, according to certain embodiments. As shown in FIGS. 7A-7B, the definition may include properties 410, data type 420, comments 430, and event tab 610. The properties 410 can include things such as name, timestamps, duration planned, duration average, and so on. The data type 420 can include things like text, list, array doubles, or the like. The comments 430 can provide the values for the properties, particularly in the case of text and list data type properties. The event tabs 610 can include things like ship, reports, sensor/equipment, information, people, and procedures/checklists.

As with an execution event, a milestone event can be considered an extension of an event.

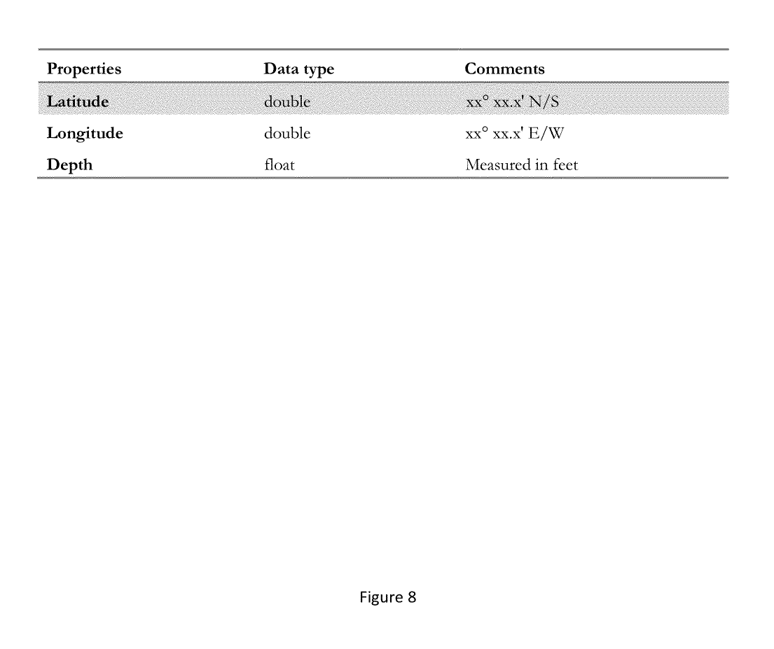

FIG. 8 illustrates a more detailed example of a definition of a position tag. As shown in FIG. 8, the definition may include properties 410, data type 420, and comments 430. The properties 410 can include things such as latitude, longitude, depth, altitude, and the like. The data type 420 can include things like double or float. The comments 430 can provide the values for the properties.

In other words, position can typically include eight data elements: latitude degrees, latitude minutes, latitude label (N/S), longitude degrees, longitude minutes, and longitude label (E/W).

A user can have the ability to search for an existing mission using any of the defined parameters. A user may enter a single parameter or a combination of parameters to search. The user search can return results based upon the search criteria.

As mentioned above, an application according to certain embodiments may have multiple views. Views can allow the user several ways of visualizing a mission and the events that make up a mission.

A geographic (Geo) view can plot articulation points on a map and can allow the user the ability to change routes on the map. The Geo view can allow the user to add new events and articulation points by simply tapping a leg of an event.

A time distance view can use an x and y axis to plot time versus distance. This view can allow a user to make adjustments to the time that an execution event occurs. Execution events can impact time and distance. Thus, when execution events are adjusted, the system can automatically display the impacts on the mission. For example, a user can change time based upon speed and/or distance.

A list of events view can allow a user to view a list of events that make up a mission. This list of events view can have various columns corresponding to various properties of the events, with the events presented as rows across the columns.

The following discussion relates to a particular scenario, in which the user is the navigator of a first flight 688-class nuclear powered submarine. The user is completing a transit east to west across the Indian Ocean and is assigned to covertly transit through the Strait of Hormuz into the Arabian Sea. The user has an tablet with a system, according to a particular embodiment of the present invention, in order to perform this task.

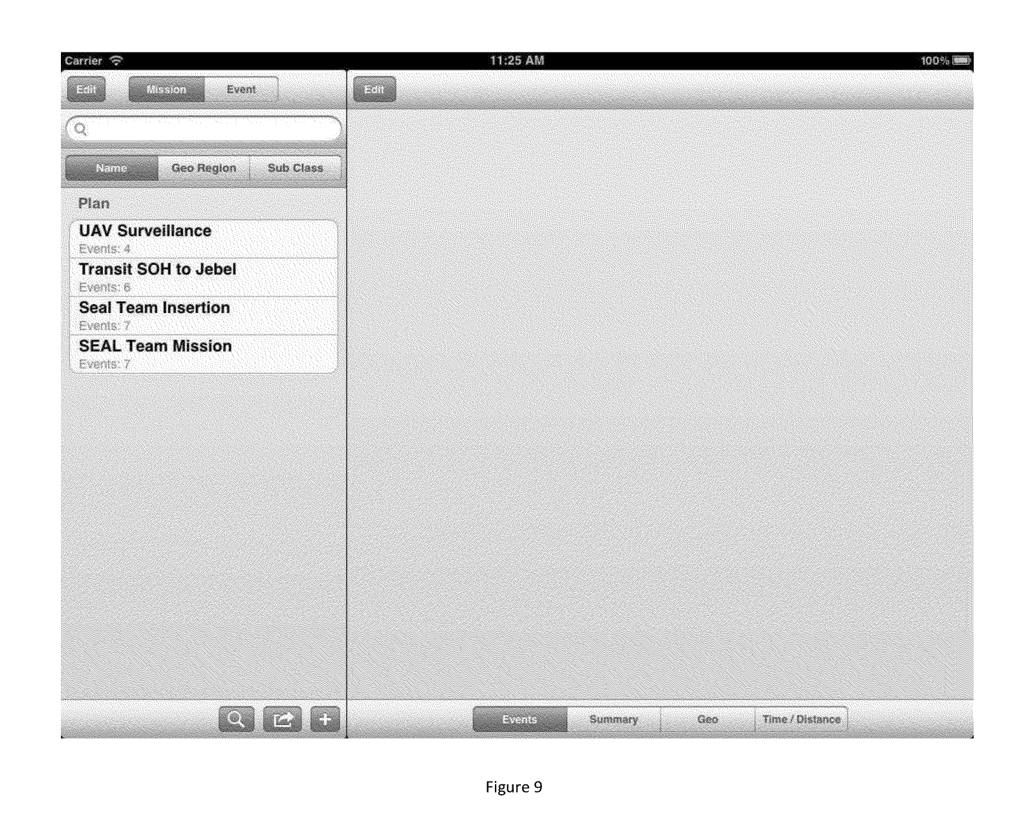

FIG. 9 shows an initial user interface view according to certain embodiments. As shown in FIG. 9, after opening the system, the user can be presented with a familiar split-view tablet view. The Plan-Brief-Execute-Assess selections can control the views and applications for the plan. The library can show the files shared among the submarine force. These can include more than just planning files. However, initially the planner may only be interested in getting this plan built. Thus, the user may select Build Plan to get started.

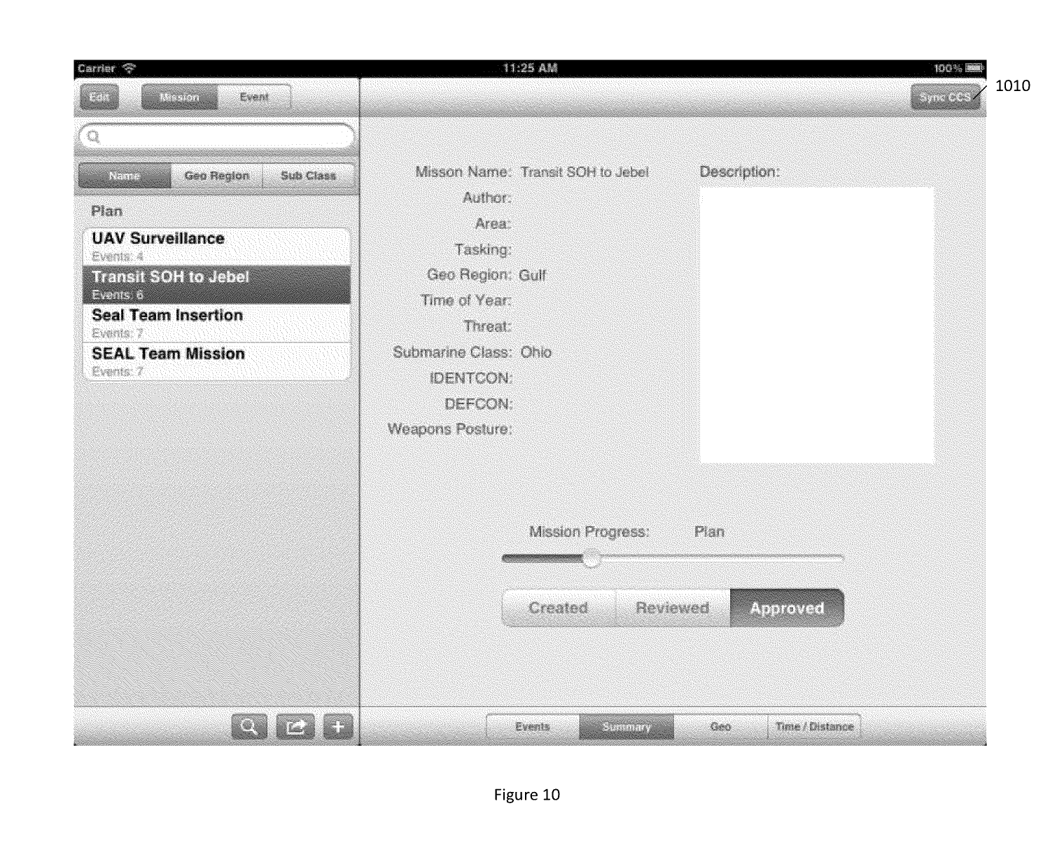

FIG. 10 illustrates syncing in a user interface according to certain embodiments. As shown in FIG. 10, the planning can start with a sync from the CCS, for example using sync CCS button 1010. The system can look for mission assignments from the operational commander, equipment configuration, equipment status, navigational and environmental data, enemy OOB, list of qualified watchstanders, approved procedures, standing orders, and checklists.

The user can touch the sync button 1010 to secure wirelessly download data from CCS. The interface with the CCS could be wireless or through a sync cable.

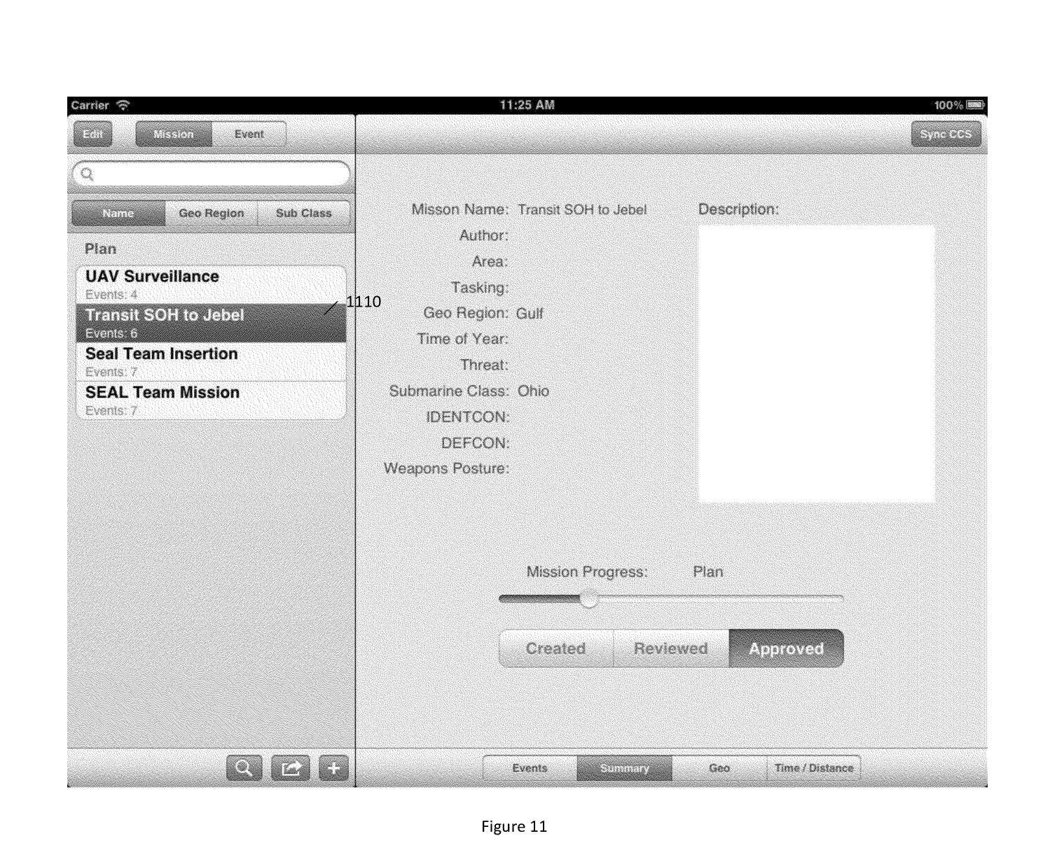

FIG. 11 illustrates selection of a mission for planning according to certain embodiments. As shown in FIG. 11, after sync the user can select the mission to plan. In this case, “Transit SOH to Jebel” at 1110 has been selected. Because this mission was downloaded, it may contain basic mission attributes including a word description of the objective, and also including basic parameters such as IDENTCON, THREATCON, DEFCON, and the like. The system can rank previously built submarine missions and display them by relevance. The system can heavily favors missions where there is a match for submarine class and flight, mission area, and objective.

Other organizations besides submarine crews can build missions. For example, planner users can include users at a Submarine Learning Center and in SCC classes.

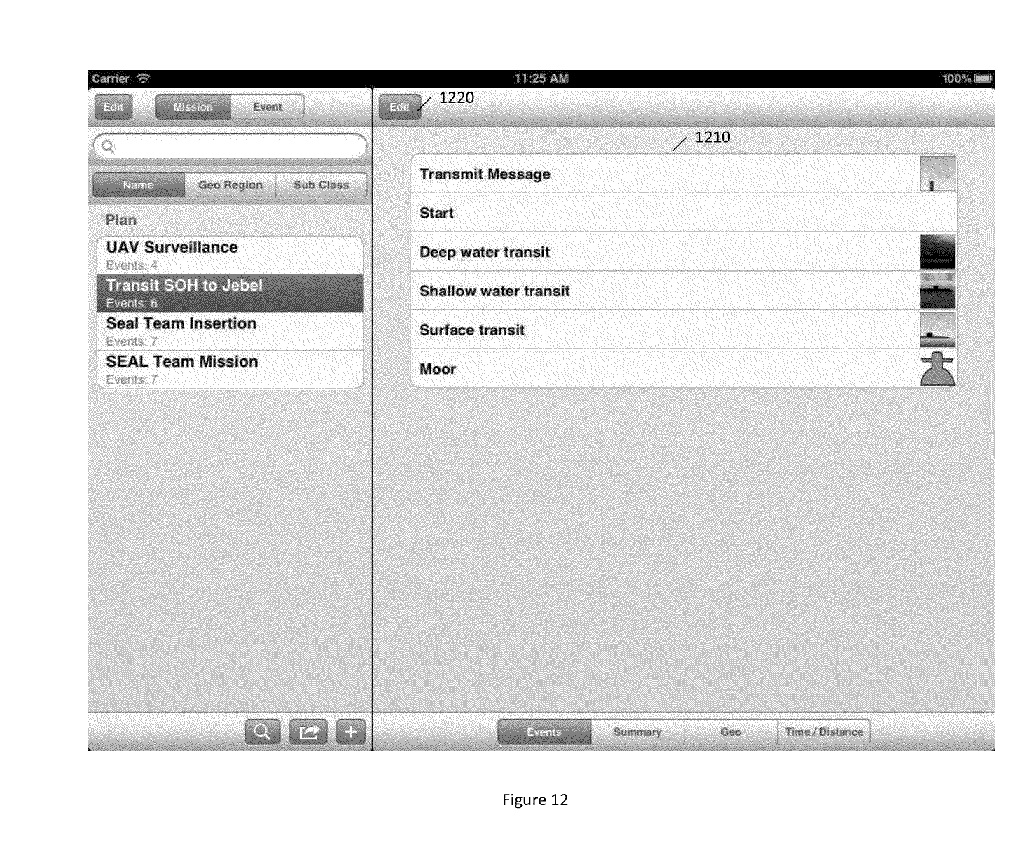

FIG. 12 illustrates an event list view according to certain embodiments. An event list is shown at 1210. These events can be the tasks and deliverables of the current planning process. In this case, the four events are as follows: deep water transit, shallow water transit, surface transit, and mooring.

For planning, the system can use three views: an event list view, a Geo view, and a time-distance view. The event list view can be used to make sure that the basic sequence of events is correct. The edit button at 1220 can be used to modify the list using drag and drop.

The user can eventually be using the Time-Distance View and the Geo view. These views can be driven from a common model so that event endpoints, or touchpoints, can all correspond.

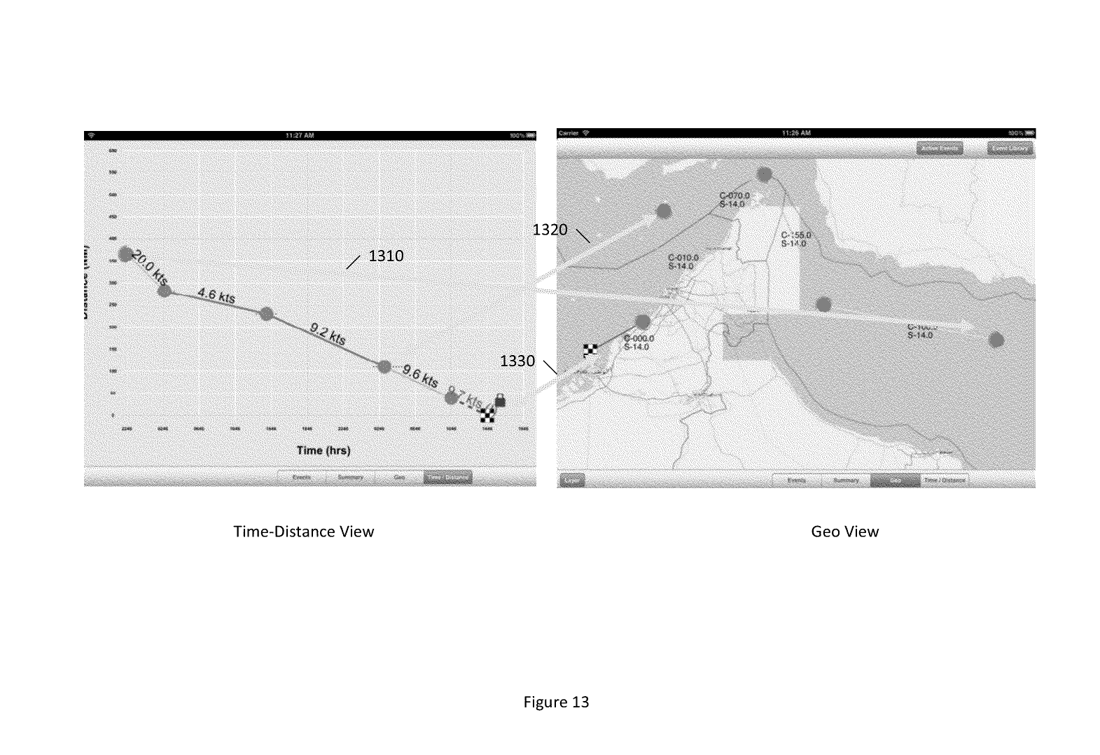

FIG. 13 illustrates the interrelationship between a time-distance view and a geographic view according to certain embodiments. As shown in FIG. 13, a starting point 1310 can be located geographically on the right in Geo view, while it is located chronologically to the left in the time-distance view. Moreover, a middle point 1320 can be located geographically up from the start point, while being located lower on the distance axis in the time-distance view. Finally, the end point 1330 can be located at the final destination in the Geo view and at the time axis in the time-distance view.

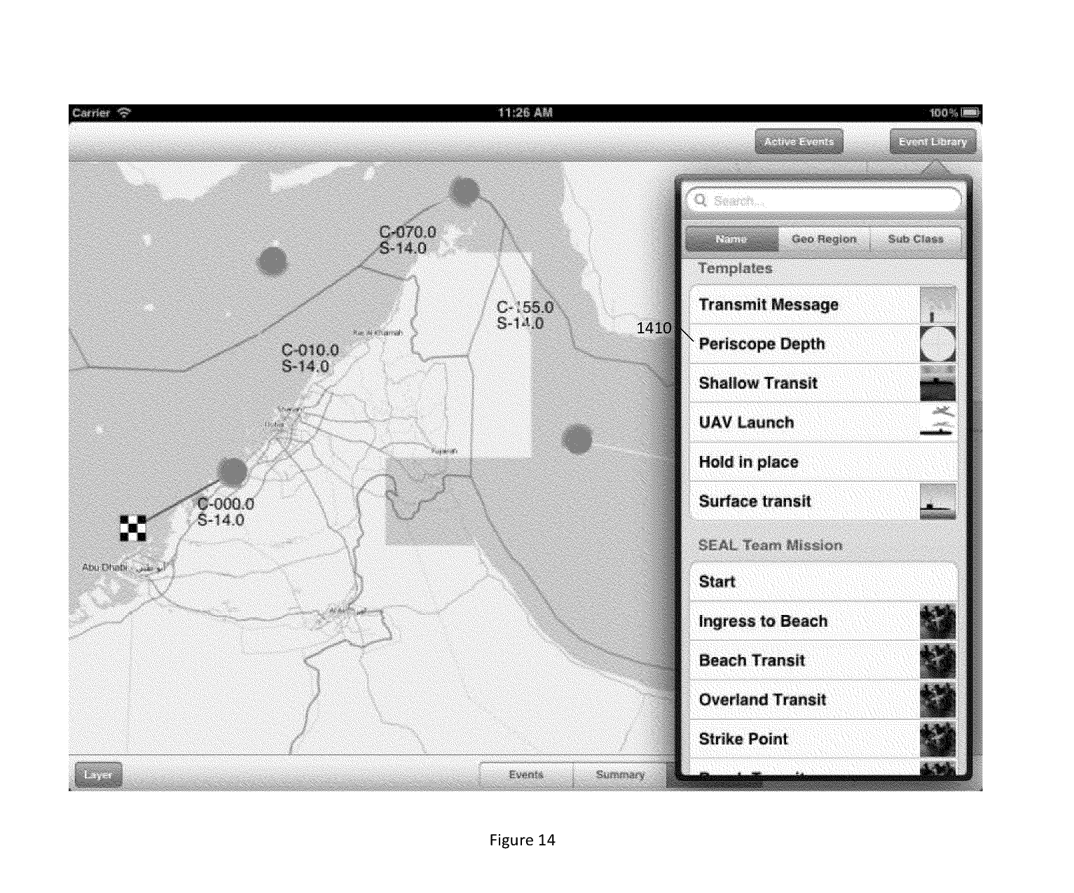

FIG. 14 illustrates a combination of a Geo view and an event list view according to certain embodiments. The system can handle at least two types of events: execution events and milestone events, as discussed above. Execution events can take time and sometimes space. Physically moving from one location to another is an execution event. Also, going to periscope depth, as indicated at 1410, or deploying an array can be an execution event. Milestone events can be decision and deliverable events. Events can be reordered or, in certain embodiments, placed in parallel. The user can select an event library to view events that other users have added.

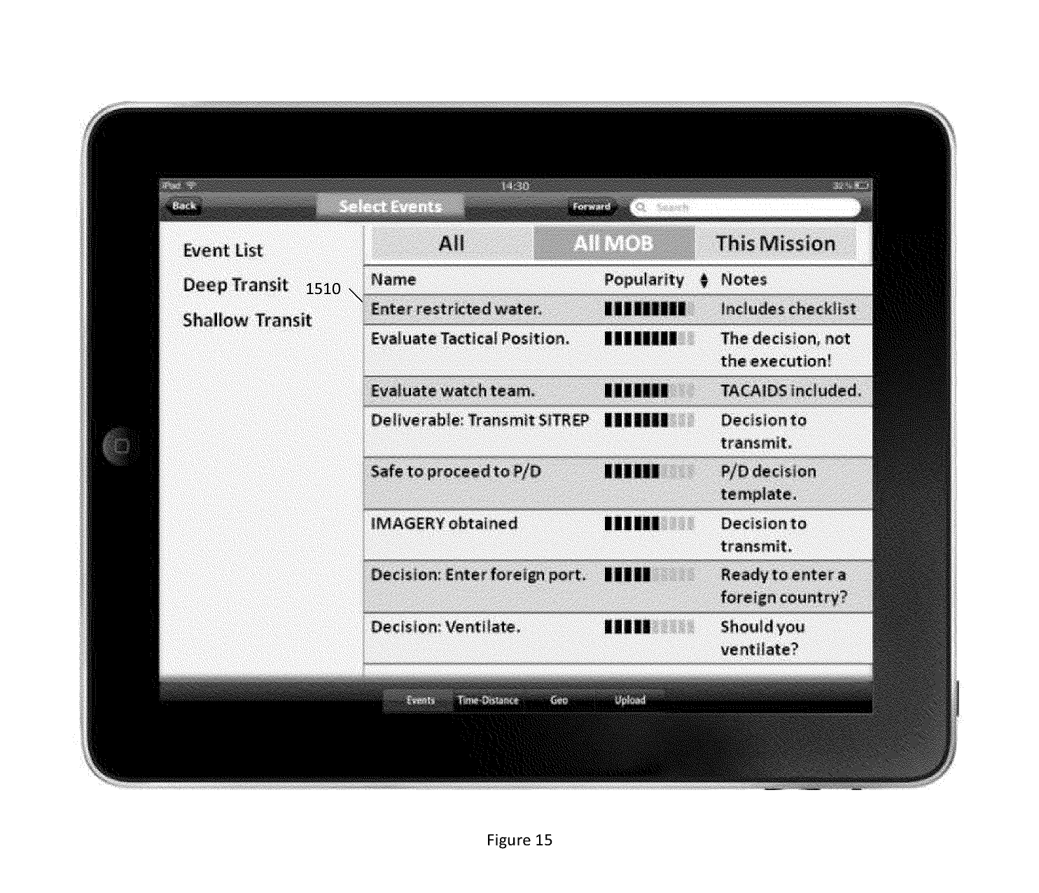

FIG. 15 illustrates event selection according to certain embodiments. As shown in FIG. 15, the system can provide a collaborative sharing structure for events as well as missions, and can indicate download popularity of events. The system can present the user with a list of events the user community has already defined.

The user can review all events, events associated with mobility missions, or just events associated with this mission. The user can sort by popularity and see that there is a decision event to enter restricted water at the top, at 1510. The user can then select this event, keeping in mind that there may need to carefully consider decisions to be made prior to taking on risk.

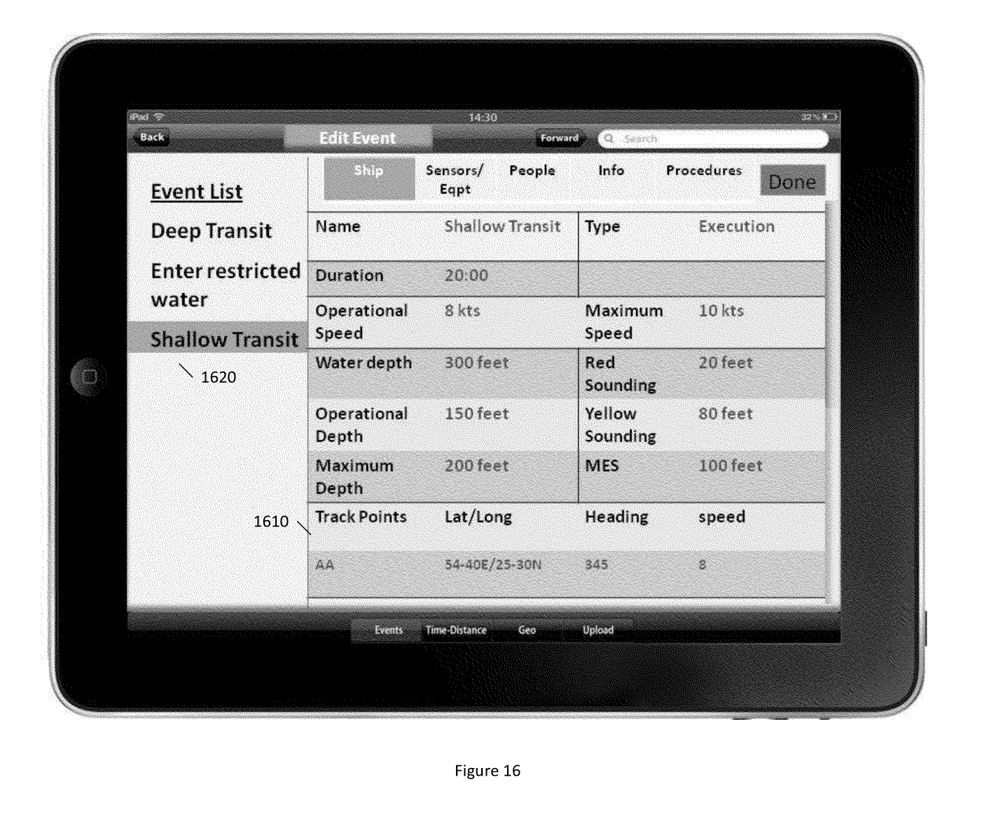

FIG. 16 illustrates event editing according to certain embodiments. As shown in FIG. 16, the user may be satisfied with the event list and may inspect the properties of these events.

For execution events, properties can be grouped into categories. In the ship category, for example, the user can review important properties including operational speed, or planned speed, and maximum speed, which can act as a constraint. Track points may or may not be included with events but are included in this case, at 1610. When the user is satisfied with the properties of the shallow water transit, at 1620, the user can page through the other events to review their respective properties.

Similar to the execution events, milestone events have groups of properties. The property groups of milestone events include information requirements, authorities, decision parameters and criteria. Decision events can be a tool for managing risk versus gain. When a user is finished reviewing event properties, the user may, for example, a select Geo view. The order of these selections may be selected by the user based on the user's interests.

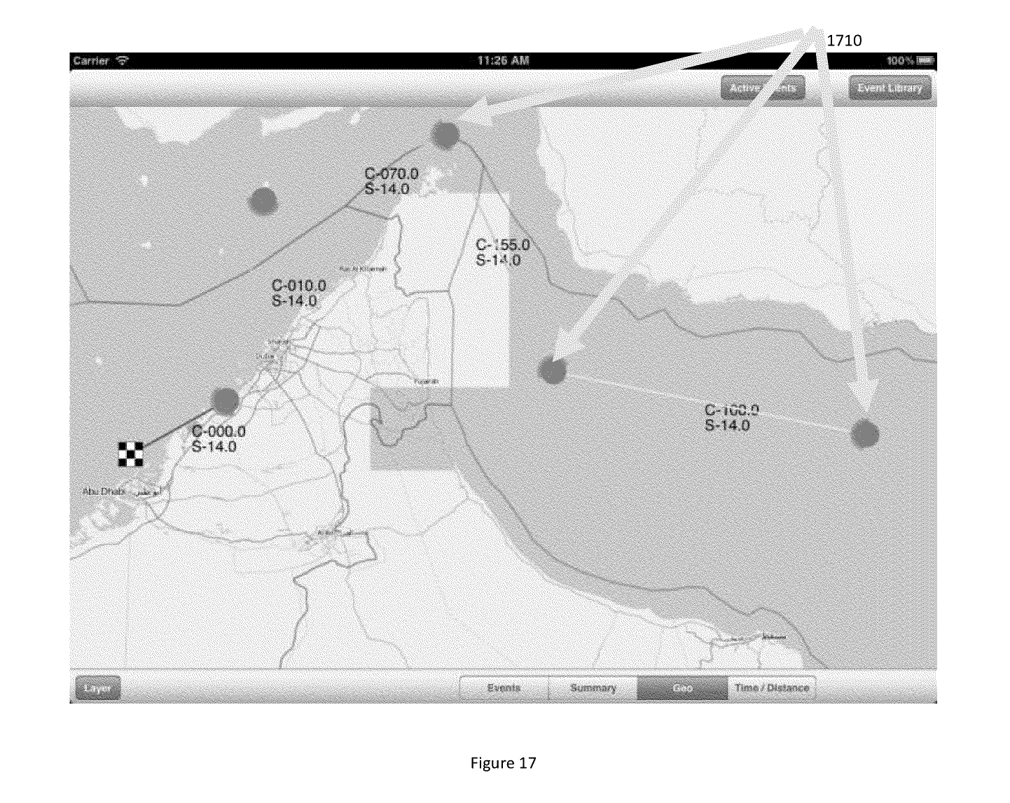

FIG. 17 illustrates way points in a geographic view according to certain embodiments. As shown in FIG. 17, because waypoints 1710 were included in these execution events, the mission can be laid out as shown in FIG. 17. If waypoints had not been included, the mission could lay out as a straight line.

The circles on the screen are articulation points. The start and end points for the two execution events as well as the internal waypoints can be moved by, for example, touch and drag. Since the system can use a common model for all three views, changes in one view can be reflected in each of the others.

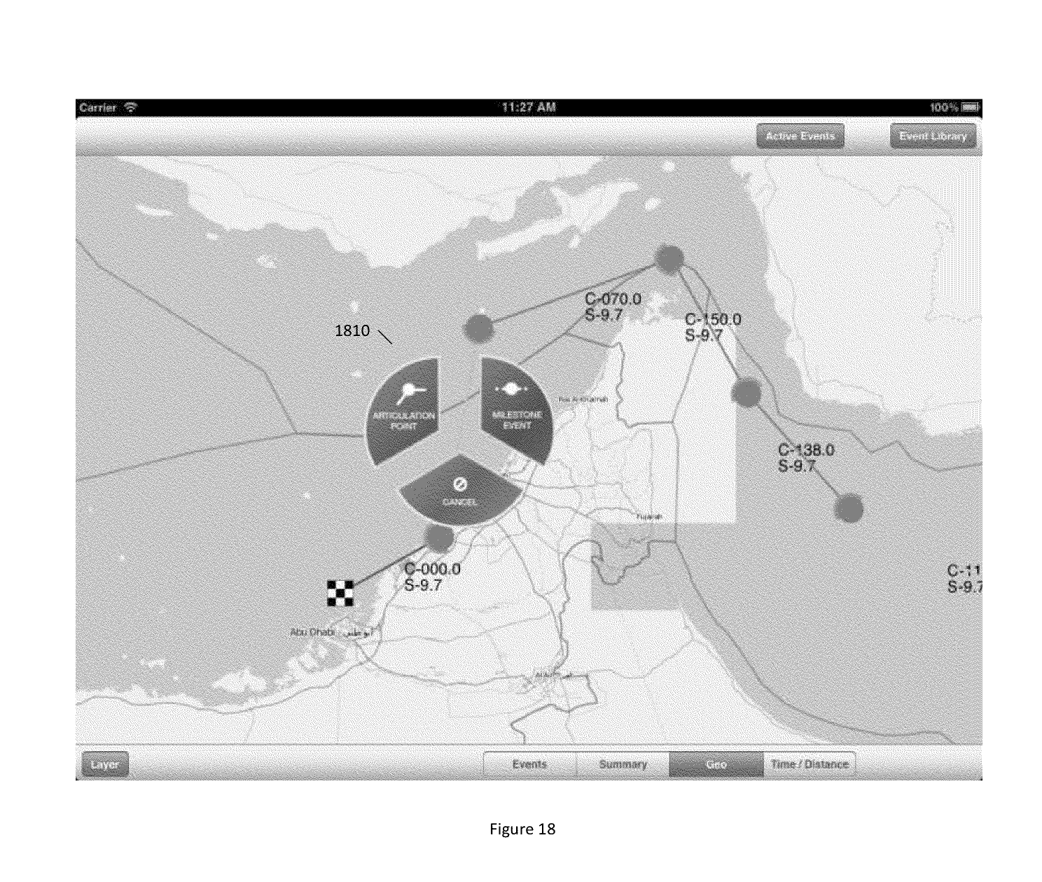

FIG. 18 illustrates editing of a connecting line according to certain embodiments. As shown in FIG. 18, a user can add an articulation point or milestone event to the leg of a mission simply by tapping the connecting line and selecting from an exploded pie chart menu at 1810. Once the user selects articulation point or milestone event, the user can then name the event within the Geo view. To adjust the position of the event the user can drag and drop.

The GEO view can use layers to show various database elements to the planner. For example, the user can review environmental data and shipping density. Another layer can be a show tracks layer. The show tracks layer can be layer that allows the user to see the actual tracks of previous submarines performing this mission. This may be possible because in execution mode the actual position is recorded. Upon mission completion and upload, a global library can then maintain that track history. Based on the actual tracks being slightly to the right of the planned track, for example, the user could touch and drag the center track point to the right slightly. The user can then select the Time-Distance (TD) view.

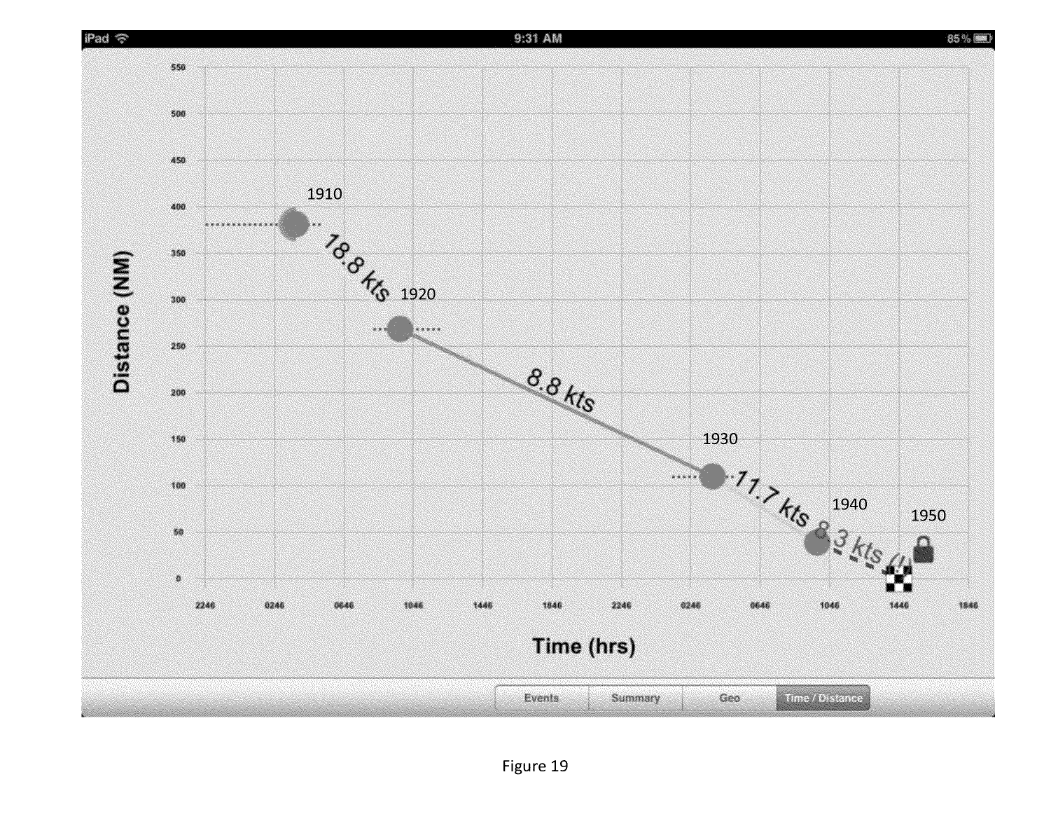

FIG. 19 illustrates unbalanced risk displayed to a user in a time-distance view according to certain embodiments. The TD view can be particularly useful for a transit mission. This view can show distance to go against time. The slope of the line in the TD view can represent speed.

There can be touch points 1910, 1920, 1930, 1940, and 1950 to manipulate. These touch points can correspond to the touch points in Geo view and to the start and stop of the execution events in Event List view.

The TD view can display dotted horizontal lines through the touch points indicating the degree of freedom for the touch points and the extent to which the point can be manipulated prior to reaching a constraint.

In a particular case, a crew may have completed an extensive deep water transit but may not have much experience in shallow water. Thus, the user may decide to give up margin in the deep water event to gain margin in the shallow water event.

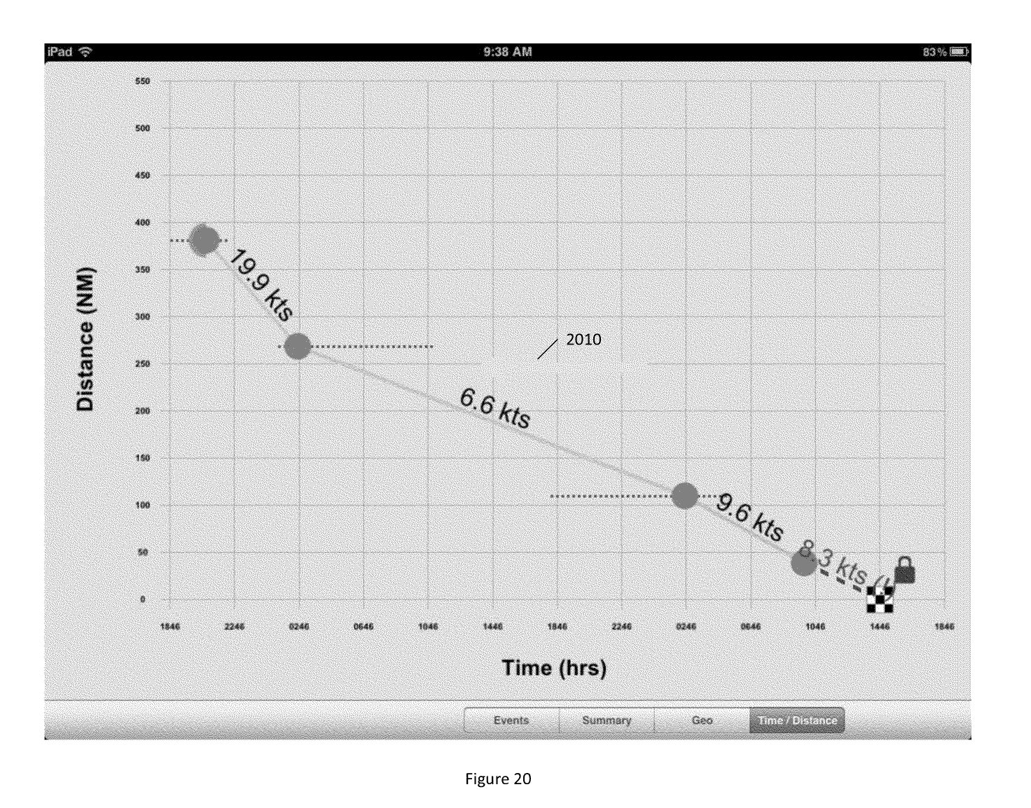

FIG. 20 illustrates balanced risk displayed to a user in a time-distance view according to certain embodiments. As shown in FIG. 20, the user can touch the center touch point and slide the user's finger or a stylus to the left at 2010, parallel to the X-axis. This can keep the distance constant and can keep the position on the chart, but can adjusts the time for the end of the deep water transit and the start of the shallow water transit to an earlier time. As the user makes this adjustment, the deep water transit line gets steeper indicating higher speeds, and redder, indicating that the user is approaching a constraint. The shallow water transit line can get flatter and greener, indicating slower speeds further from a constraint.

A label indicating speed can show as the touch point is moved. In this case, the user can drag nearly all the way to the left, with 19.9 kts for the deep water transit. Thus, the shallow water transit speed has been decreased to 6.6 kts. Because the system can use a common model, the changes made in the TD view can be seen in the Event List view.

Likewise, other variations of the plan can be explored. For example, again, to compensate for the lack of shallow water experience of the crew, the user could contemplate starting the shallow water transit mode 10 miles earlier. Again, by touching on the middle touch point and sliding a finger or stylus up or down, parallel to the Y-axis, the user can evaluate the impact of that change on the operational speed of each leg.

Another question the user can explore is a question of how long the starting time can be delayed before the required deep water transit speed reaches 23 kts. This question can be answered by touching the upper left start point and sliding it to the right until 23 kts is displayed. In this case, the maximum delay may be one hour and 3 minutes.

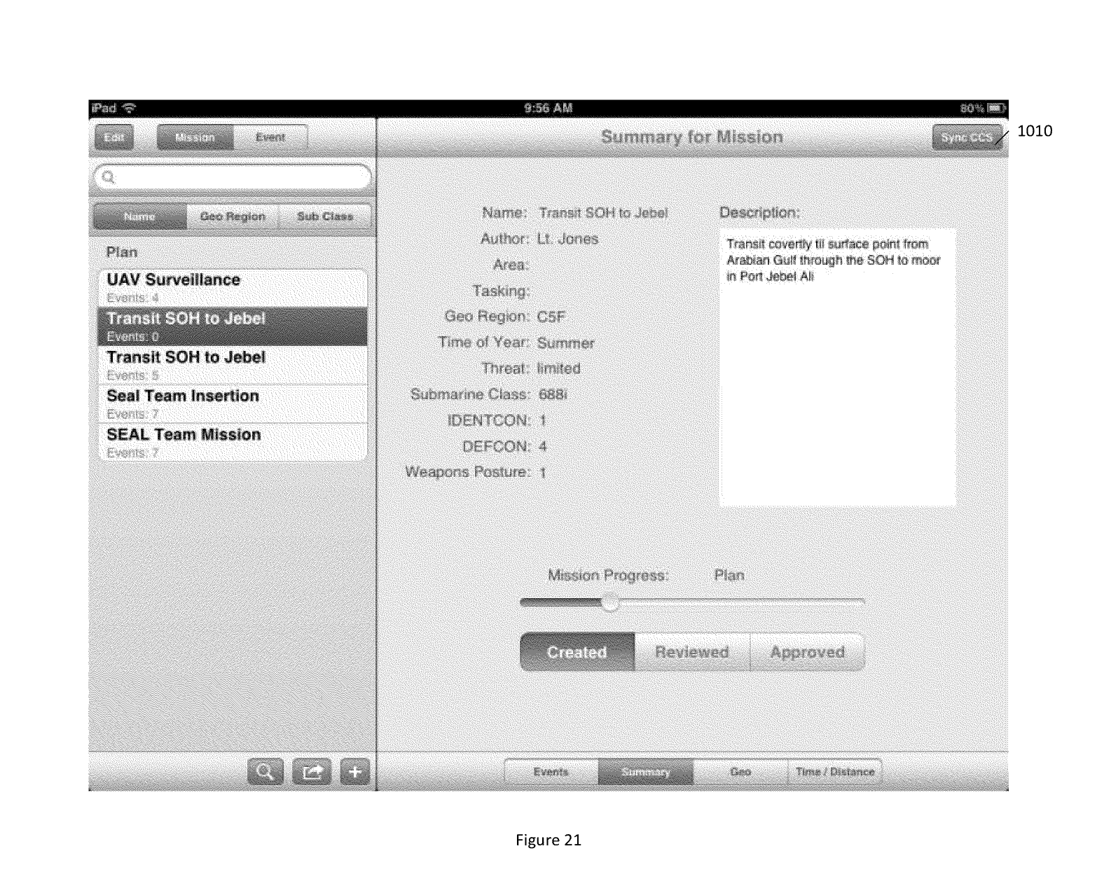

FIG. 21 illustrates a mission summary ready for submission according to certain embodiments. When the user is satisfied with the plan and is ready to have it reviewed, the user can carry the tablet up to see the XO and the CO. After approval, the user upload the plan to the CCS.

After selection of an upload button, the user can be presented with the Upload screen. At this screen, the user can select whether to send the entire plan to the CCS or just parts. Key parts of the plan to be uploaded to the CCS can include the track plan, sensor plan and navigation plan. Watchbills and decision checklists can also be uploaded. Using the sync CCS button 1010, the user can sync the plan with CCS.

At this point, planning can be complete. The brief mode, mentioned above, can allow print out of briefing materials and display of a movie showing the submarine moving in the Geo view with key events. The execute mode, also mentioned above, can record ship position and can allow comparison of the ship's actual position with the planned position. Furthermore, the assess mode can allow recording of after action comments. Since files are shared, this function of the system can serve as the submarine force's lessons learned repository.

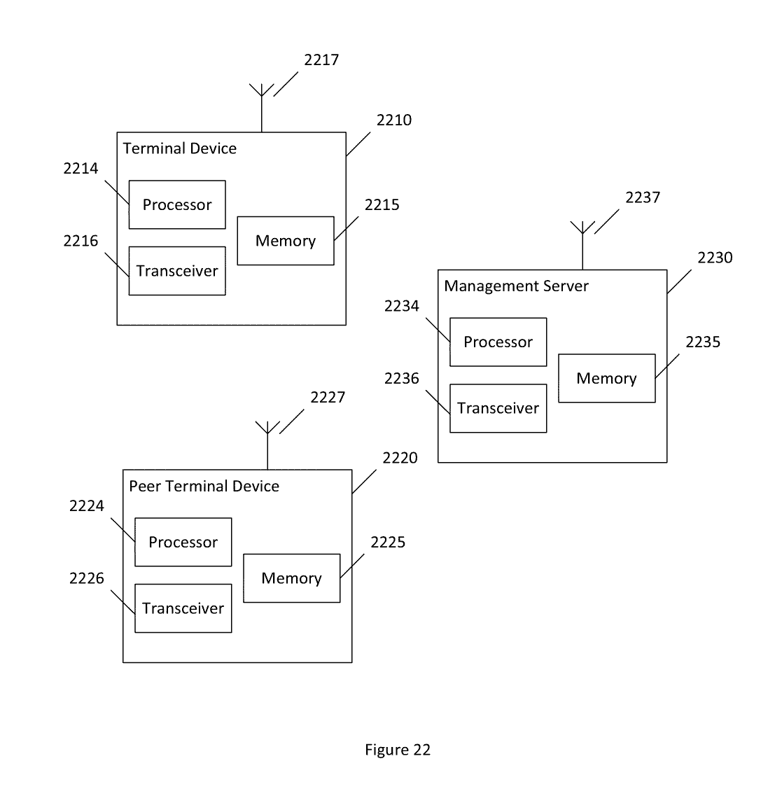

FIG. 22 illustrates a system according to certain embodiments of the invention. In one embodiment, a system may include multiple devices, such as, for example, at least one terminal device 2210, at least one peer terminal device 2220, and at least one management server 2230. In certain systems, only terminal device 2210 and management server 2230 may be present. Other configurations are also possible. The terminal device 2210 and the peer terminal device 2220 may each be a laptop, tablet, smart phone, or other terminal device, such as a portable terminal device. The management server 2230 may be a computer for a dispatch center, for a command center, or for another administrative or supervisory function.

Each of these devices may include at least one processor, respectively indicated as 2214, 2224, and 2234. At least one memory can be provided in each device, as indicated at 2215, 2225, and 2235, respectively. The memory may include computer program instructions or computer code contained therein. The processors 2214, 2224, and 2234 and memories 2215, 2225, and 2235, or a subset thereof, can be configured to provide means corresponding to the various blocks of FIG. 1. Although not shown, the devices may also include positioning hardware, such as global positioning system (GPS) or micro electrical mechanical system (MEMS) hardware, which can be used to determine a location of the device. Other sensors are also permitted and can be included to determine location, elevation, orientation, and so forth, such as barometers, compasses, and the like.

As shown in FIG. 22, transceivers 2216, 2226, and 2236 can be provided, and each device may also include at least one antenna, respectively illustrated as 2217, 2227, and 2237. Other configurations of these devices, for example, may be provided. For example, management server 2230 may be configured for wired communication, rather than wireless communication, and in such a case antenna 2237 would illustrate any form of communication hardware, without requiring a conventional antenna.

Transceivers 2216, 2226, and 2236 can each, independently, be a transmitter, a receiver, or both a transmitter and a receiver, or a unit or device that is configured both for transmission and reception.

Processors 2214, 2224, and 2234 can be embodied by any computational or data processing device, such as a central processing unit (CPU), application specific integrated circuit (ASIC), or comparable device. The processors can be implemented as a single controller, or a plurality of controllers or processors.

Memories 2215, 2225, and 2235 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as terminal device 2210, peer terminal device 2220, and management server 2230, to perform any of the processes described above (see, for example, FIG. 1). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 22 illustrates a system including a terminal device, peer terminal device, and management server, embodiments of the invention may be applicable to other configurations, and configurations involving additional elements. For example, not shown, the terminal device 2210 and peer terminal device 2220 may be in communication with a wireless local area network.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. For example, although various kinds of projects have been mentioned, such as military, medical, educational, and transportation projects, certain embodiments can be employed in connection with other kinds of projects. In order to determine the metes and bounds of the invention, therefore, reference should be made to the appended claims.

### GLOSSARY OF NAVAL TERMS

NMETLS Navy Mission Essential Task Lists

NTIMS Naval Training Information Management System

NRRE Navy Readiness Reporting Enterprise

NWTS Navy Warfare Training System

MRC Navy form, Maintenance Requirement Card

SCC Navy form, Sequence Control Card. Sequence control charts/cards (SCCs) are graphic, sequential work displays. They are prepared to ensure the orderly planning and timely performance of aircraft and engine maintenance requirements. The SCCs integrate all required periodic maintenance work to effectively reduce the total out-of-service time required for a complete scheduled maintenance job.

I claim:

1. A method, comprising:
presenting a list of events in a chronological order;
linking each of the events to at least one chronological neighbor event, said linking done with respect to a non-chronological parameter of said at least one chronological neighbor event;
responsive to a user selection, changing the chronological order of the list of events; and
relinking events having at least one changed neighbor event upon changing the chronological order.

2. The method of claim 1, wherein the non-chronological parameter comprises a geographic parameter.

3. The method of claim 1, wherein each event is defined by a process and an endpoint in time and position.

4. The method of claim 1, wherein linking each of the events comprises beginning a process of a second event at an endpoint of the first event.

5. The method of claim 1, further comprising:
presenting the list of events on a plurality of axes, the plurality of axes comprising a time axis and a position axis.

6. The method of claim 1, further comprising:
responsive to a second user selection changing a rate of a process of an event, changing an endpoint of the event, and changing at least one of a rate or an endpoint of a neighbor event.

7. The method of claim 1, further comprising:
determining a proximity to risk for each event; and
indicating the proximity to risk to the user.

8. The method of claim 7, wherein indicating the proximity to risk comprises changing a color associated with the event.

9. The method of claim 1, further comprising:
sharing the list of events with a library of lists of events.

10. The method of claim 1, wherein the events comprise treatment procedures for treating a patient.

11. An apparatus, comprising:
at least one processor; and
at least one memory including computer program code,
wherein the at least one memory and the computer program code are configured to, with the at least one processor, cause the apparatus at least to present a list of events in a chronological order;
link each of the events to at least one chronological neighbor event, said linking done with respect to a non-chronological parameter of said at least one chronological neighbor event;
responsive to a user selection, change the chronological order of the list of events; and
relink events having at least one changed neighbor event upon changing the chronological order.

12. The apparatus of claim 11, wherein the non-chronological parameter comprises a geographic parameter.

13. The apparatus of claim 11, wherein each event is defined by a process and an endpoint in time and position.

14. The apparatus of claim 11, wherein the at least one memory and the computer program code are configured to, with the at least one processor, cause the apparatus at least to link each of the events by beginning a process of a second event at an endpoint of the first event.

15. The apparatus of claim 11, wherein the at least one memory and the computer program code are configured to, with the at least one processor, cause the apparatus at least to present the list of events on a plurality of axes, the plurality of axes comprising a time axis and a position axis.

16. The apparatus of claim 11, wherein the at least one memory and the computer program code are configured to, with the at least one processor, cause the apparatus at least to, responsive to a second user selection change a rate of a process of an event, change an endpoint of the event, and change at least one of a rate or an endpoint of a neighbor event.

17. The apparatus of claim 11, wherein the at least one memory and the computer program code are configured to, with the at least one processor, cause the apparatus at least to:
determine a proximity to risk for each event; and
indicate the proximity to risk to the user.

18. The apparatus of claim 17, wherein the at least one memory and the computer program code are configured to, with the at least one processor, cause the apparatus at least to indicate the proximity to risk by changing a color associated with the event.

19. The apparatus of claim 11, wherein the at least one memory and the computer program code are configured to, with the at least one processor, cause the apparatus at least to share the list of events with a library of lists of events.

20. The apparatus of claim 11, wherein the events comprise treatment procedures for treating a patient.

21. A non-transitory computer-readable medium encoded with instructions that, when executed in hardware, perform a process, the process comprising:
presenting a list of events in a chronological order;
linking each of the events to at least one chronological neighbor event, said linking done with respect to a non-chronological parameter of said at least one chronological neighbor event;
responsive to a user selection, changing the chronological order of the list of events; and
relinking events having at least one changed neighbor event upon changing the chronological order.
